(19) United States
(12) Patent Application Publication
(10) Pub. No.: US 2004/0054973 A1
(43) Pub. Date: Mar. 18, 2004

(54) Method and apparatus for transforming contents on the web

(76) Inventor: Akio Yamamoto, Yokohama-shi Kanagawa (JP)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/381,507

(22) PCT Filed: Oct. 2, 2001
(86) PCT No.: PCT/US01/30691

(30) Foreign Application Priority Data
Oct. 2, 2000 (JP) 2000-302728

(51) Int. Cl. G06F 15/00

(52) U.S. Cl. 715/530

(57) ABSTRACT

Web contents requested by a user (client device) and, the results of the semantic analysis of the Web contents are retrieved. The requested Web contents are appropriately transformed on the basis of the information items of the Web contents and semantic analysis results, and in accordance with the user's requests or the attributes of the client device, whereupon the transformed Web contents are transmitted to the client device. Thus, even the user of a palmtop computer, a handheld computer or a portable telephone whose display panel is small in size can access the Web contents conveniently and efficiently.

### BACKGROUND OF THE INVENTION

1. Field of the Invention

The present invention relates to a method for providing document contents by a Web server. More particularly, it relates to a method and an apparatus in which, in providing Web contents to a client (or browser), a document is appropriately transformed on the basis of the results of the semantic analysis of the contents.

2. Description of the Related Art

The Internet which is the network of computers distributed all over the world, has its importance and effectiveness recognized extensively as a medium through which a plurality of computers are able to communicate with one another. The World Wide Web which is constructed of a plurality of server computers (Web servers) connected to the Internet and storing contents information (Web pages) therein, and a multiplicity of clients for accessing the information, is an information providing service on the Internet as has been most highlighted in recent years. The service can provide and exchange, not only text information, but also graphics and image information, audio and video information, etc. Also intranets which are the private computer networks of enterprises, can easily provide and share information within the enterprises by way of example and are in widespread use. A Web browser having a graphical user interface, such as Netscape Navigator or Internet Explorer operating on a computer, has been usually employed in order to access the information provided by the Internet and the intranets.

Owing to the recent rapid progress of mobile computing technology, clients who use, not only conventional desktop computers, but also palmtop or handheld computers, have increased in number. Besides, more people have come to access the Internet using portable telephones adapted to be connected with networks. In general, in a mobile device such as the palmtop/handheld computer or the portable telephone, a display panel is smaller in size than that of the desktop computer and as often inferior in the capabilities of color display etc. As a result, unless Web contents are transformed in any way, part of the Web contents displayable on the display panel of the desktop computer becomes undisplayable on that of the mobile device in some cases. Moreover, the Web contents might fail to be correctly displayed due to limits of the performances of the mobile terminal device, such as the size of an installed memory and the bandwidth of the connection with the network.

A prior-art example for coping with these problems is schematically shown in FIG. 1. There has been mainly adopted a method wherein, as shown in the figure. Web contents are transformed in conformity with the properties of a device which is used for access. By way of example, a color image of large size has its size reduced and is transformed into a black-and-white image of low resolution as stated in Japanese Patents Laid-Open No. 345178/1999, No. 122958/2000, No. 222275/2000 and No. 222276/2000. Besides, document contents are subjected to such processing as the alteration of the font or font size of a text, or the division of the contents into parts of smaller size each of which can be displayed on the display panel of the mobile device. Nevertheless, drawbacks to be mentioned below are pointed out.

With the transformation conforming to the properties of the mobile terminal used by a client, the Web contents are essentially the same, and merely the display of the contents on, for example, the display panel of small size is facilitated. On the other hand, in a case where a method for dividing the document contents is not appropriate, access to the contents might become complicated to inconvenience the client.

### SUMMARY OF THE INVENTION

In view of the above drawbacks, the present invention has for its object to transform Web contents so that a more efficient access facility can be provided to the user of a mobile terminal device, in addition to the facilitation of the display of the contents on the display panel of the mobile device.

Another object of the present invention is to transform Web contents so that a navigation mechanism can be realized which has hyperlinks permitting a client to readily judge whether or not the contents are necessary for him/her, without going through all the contents, and permitting the client to immediately move to a place that seems to be important within the contents.

Still another object of the present invention is to transform Web contents so that a facility which permits a client to browse information by the least access (communication) similarly to the above can be provided, not only for the contents composed of a single document, but also for the enormous contents composed of a plurality of documents.

According to the present invention, when a request for Web contents is received from a terminal device, the requested Web contents are analyzed, and editorial information as well as formal paragraph information is extracted. These information together with the requested contents are linked to corresponding semantic analysis results. In the absence of the corresponding semantic analysis results, a semantic analysis program is executed for the requested Web contents so as to extract keywords, key sentences and/or key paragraphs from the Web contents. Also, the summary of the contents is created These semantic information items obtained are saved as the semantic analysis results. Subsequently, the requested document contents are appropriately transformed on the basis of the semantic information contained in the retrieved semantic analysis results, and in accordance with the requests of a client or the attributes of the terminal device. Here, the processing of the transformation includes the creation of a top page which is formed of the title and other editorial information of the document, and menu information, the creation of a summary page, the creation of the lists of keywords, key sentences etc. and links to places where the keywords etc. appear, and the creation of the hyperlinks among the created pages. The Web contents are displayed on the terminal device interactively in compliance with the requests of the client.

### BRIEF DESCRIPTION OF THE DRAWINGS

FIG. 1 is a block diagram showing an information access system in the prior art;

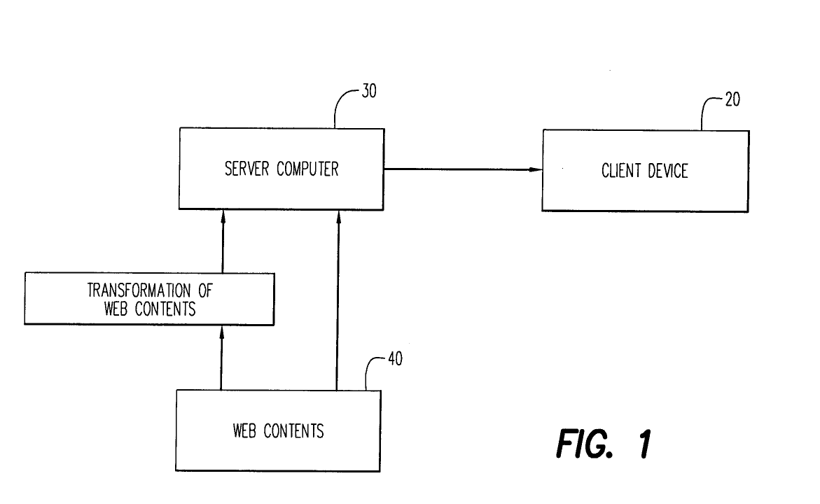

FIG. 2 is a block diagram showing the architecture of an apparatus according to the present invention;

FIG. 3 is a flow chart showing an embodiment of the present invention;

FIG. 4 is a diagram showing an example of the list of keywords in the present invention;

FIG. 5 is a diagram showing the logical structure of a transformation description object; and

FIG. 6 is a diagram for explaining user operations in the present invention.

### PREFERRED EMBODIMENTS OF THE INVENTION

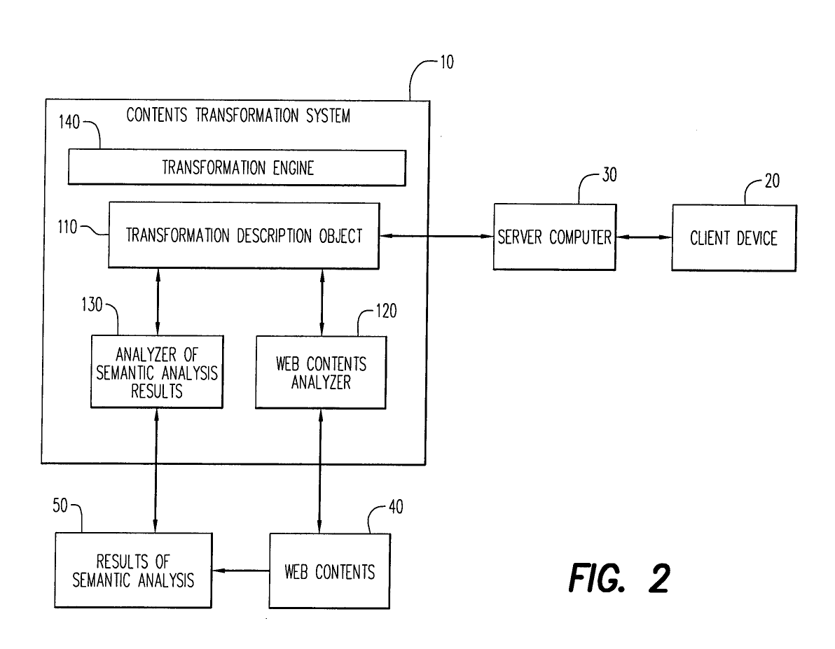

A block diagram of an information access system for performing the present invention is shown in FIG. 2. A contents transformation system 10 physically lies between a client device or terminal device 20 and Web contents 40 which a client searches for, and it functions as the interface between them. The contents transformation system 10 may well exist within a server computer 30. When the server computer 30 has received a request for access to Web contents 40 desired by the client, from the terminal device 20 connected through a communication network such as the Internet, the transformation system 10 accesses the Web contents 40 and a semantic analysis results 50 corresponding to the Web contents 40.

The “semantic analysis results 50” signify results which are obtained by extracting and analyzing semantic information contained in the Web contents 40 and are stored, and which can be generated beforehand by executing a semantic analysis program for the Web contents 40. In the absence of such semantic analysis results when the server computer 30 has received a request for access to Web contents 40, the semantic analysis program is executed to generate the semantic analysis results 50. Using a Web contents analyzer 120 and a semantic analysis results analyzer 130, the transformation system 10 generates a transformation description object 110 by employing the elements of the Web contents 40 requested by the client and the elements of the corresponding semantic analysis results 50. The transformation description object 110 contains information on the links between the lists of the elements contained in the Web contents 40 and the semantic analysis results 50, and Web contents corresponding to the elements. While the client and the contents transformation system 10 are communicating interactively, the transformation system 10 searches for information desired by the client, in conformity with the properties of the terminal device 20 possessed by the client or in compliance with a request made by the client, and it transmits the desired information to the terminal device 20 through the server computer 30 so as to indicate the information on the display thereof.

Numeral 140 designates a transformation engine which will be explained later.

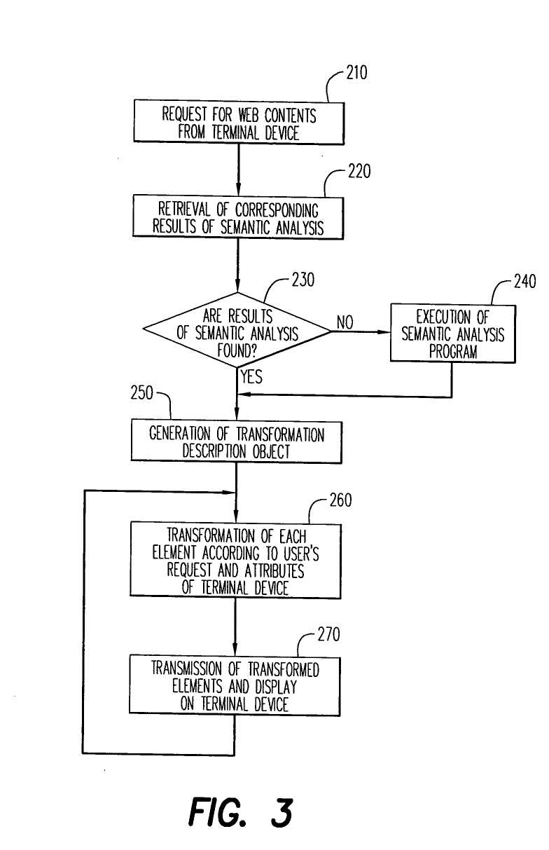

Now, an embodiment of the present invention will be described. The flow chart of the embodiment is illustrated in FIG. 3.

Step 210: A terminal device makes a request for access to Web contents.

Step 220: The results of a semantic analysis concerning the requested Web contents are retrieved.

Step 230: It is checked if the semantic analysis results are found.

Step 240: Unless the semantic analysis results are found, a semantic analysis program is executed.

Step 250: A transformation description object is generated by analyzing the Web contents and the semantic analysis results.

Step 260: Each element of the Web contents is transformed in accordance with the request of a user and the attributes of the terminal device.

Step 270: The transformed elements are transmitted, and are displayed on the terminal device.

The embodiment will be described in detail below. A request for access to certain Web contents is transmitted from the client device 20 (in FIG. 2) connected through the communication network such as the Internet, to the server computer 30 by using the HyperText Transfer Protocol (HTTP) over transmission control protocol/Internet protocol (TCP/IP) connection. The Web contents are formatted by a standard page description language such as the eXtensible Markup Language (XML).

The operation of contents transformation which proceeds in the contents transformation system 10 is broadly made up of two processing stages

At the first stage, the contents transformation system 10 analyzes the corresponding Web contents by means of the Web contents analyzer 120 so as to extract elements contained in the Web contents. Extracted are for example, editorial information such as the title, author and date of a document, and the body of the document, as well as formal paragraph information constituting them. Simultaneously, the contents transformation system 10 links those extracted information to the semantic analysis results 50 corresponding to the Web contents 40. Using the link, the system 10 can retrieve the semantic analysis results 50 as required.

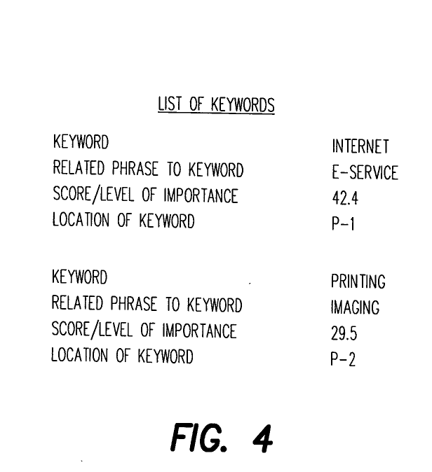

The semantic analysis results 50 hold the semantic information of the Web contents 40 in the XML format. The semantic information contains the information of extracted keywords, key sentences or key paragraphs, positions where they appear in the document, and so forth. Also contained is information on a text structure which indicates the semantic consistency of the document as obtained by analyzing the contexts between sentences. The semantic information, however, is not restricted to such exemplary information. An example of parts relevant to keywords, extracted from the semantic analysis results 50, is shown in FIG. 4.

In a case where the semantic analysis results 50 are not created beforehand, or where they are unavailable for any reason, the semantic analysis program is executed for the requested Web contents 40 so as to extract the semantic information of the contents 40. The semantic information obtained is saved as the semantic analysis results 50 in the XML format. Regarding the extraction of the keyword, a word (noun) of high frequency of appearance is set as the keyword on the basis of the assumption that the word often appearing in the document tends to indicate the theme of the document. A technique for weighting a word in accordance with the rate of appearance is detailed in “Automatic Text Processing” written by G. Salton, published by Addison-Wesley Publishing Company in 1989. Besides, the key sentence is extracted in such a way that the respective words are weighted in consideration of the frequencies of appearance of the words and the number of texts in which the words appear, and that the summation of the weights of the words which appear in the sentence is deemed the level of importance of the sentence. This method has been proposed by K. Zechner, and is stated in “Fast Generation of Abstracts from General Domain Text Corpora by Extracting Relevant Sentences” in the Proceedings of the 16th International Conference on Computational Linguistics, pp.986-989, 1996. Results obtained by the method are used also in this embodiment.

Regarding the semantic structuring of the document, the document is analyzed on the basis of a rhetorical structure analysis advocated by William C. Mann and Sandra, A. Thompson. Details concerning this method are stated in “Rhetorical Structure Theory and Text Analysis” which is contained in “Discource Description” Diverse Linguistics Analyses of a Fund-Raising Text” written by W. C. Mann & S. A. Thompson., published by John Benjamins Publishing Company in 1992.

Subsequently, the contents transformation system 10 analyzes the semantic analysis results 50 by means of the semantic analysis results analyzer 130 so as to extract, for example, the list of keywords, words or word groups deeply relevant to the respective keywords, and information on places where they appear in the document. Similarly extracted are information on the key sentences, key paragraphs and summary of the document.

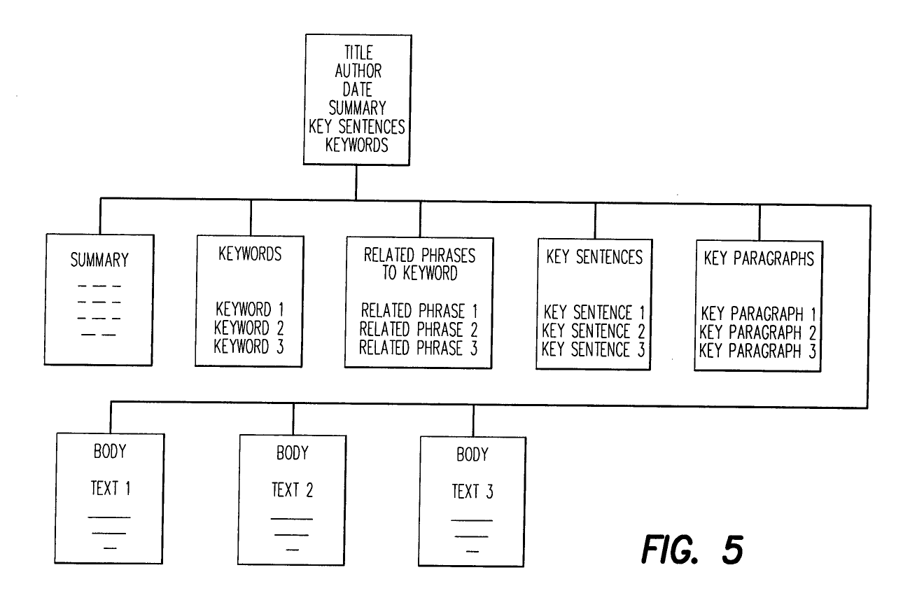

Next, using the results of the Web contents analyzer 120 and the semantic analysis results analyzer 130, the contents transformation system 10 creates the transformation description object 110. The transformation description object 110 contains link information for the Web contents 40 in which the lists of the keywords, key sentences etc. and information on the elements thereof are stored. When a client designates a desired one of the elements within the lists of the keywords, key sentences etc., the contents transformation system 10 retrieves relevant information and provides the retrieved information to the client. In this embodiment, the transformation description object 110 has a structure as shown in FIG. 5 and is expressed as an XML document object. The object 110 holds a logical structure which expresses the creations of the following elements:

(a) Top Page Information

Top page which is formed of the editorial information of the document, such as the title, author and date thereof, menu information having links to the respective information items, and so forth

(b) Summary

Page which contains only the summary of the document

(c) Keyword Page Information

Keyword page which contains the list of the extracted keywords, and links to places where the keywords appear in the document

(d) Key Phrase Page Information

Key phrase page which contains the list of key phrases relevant to the keywords, and links to places where the key phrases appear in the document

(e) Key Sentence Page Information

Key sentence page which contains the list of the extracted key sentences, and links to places where the key sentences appear in the document

(f) Key Paragraph Page Information

Key paragraph page which contains the list of the extracted key paragraphs, and links to places where the key paragraphs appear in the document

(g) Hyperlinks Among the Elements

Hyperlinks which indicate the relevance among the created pages

A method for generating the transformation description object 110 will be explained. First, the transformation engine 140 defines transformation rules, namely, a series of rules for the display aspects of the elements included in the Web contents 40 and the semantic analysis results 50, on the client device 20; the information of link destinations in the case where the elements are linked; and so forth. The transformation engine 140 transforms the respective elements included in the Web contents 40 and the semantic analysis results 50, on the basis of the transformation rules defined for all the elements. At this stage, however, the transformation engine 140 does not execute the final transformation processing of the contents yet, but it merely builds the logical structure of the transformed contents, that is, generates the object which describes transforming methods for the elements.

The transformed document can have the structure as shown in FIG. 5, as its logical structure. In this embodiment, the logical structure is formed of the top page which contains the editorial information of the document and the links to the summary, keywords and key sentences, the pages which contain the lists of the keywords, key sentences etc. and the links to the places where the keywords, key sentences etc. appear in the document, respectively, and document fragments which are obtained by dividing the body of the document into parts of appropriate size.

Further, at the second stage, the transformation processing of the contents is actually executed by the transformation engine 140. An access request from the client device 20 is transmitted to the Web server 30 by using the HTTP protocol. Herein, information items on a communication facility, a display facility, etc. incorporated in the terminal 20 can be contained as parts of an HTTP header. The transformation processing is executed for the respective elements in accordance with the information items on the terminal attributes, and the transformation description object 110 created at the first stage. Thus, the pages of the body of the document are created, while at the same time, the pages and hyperlinks (a)-(g) mentioned above are created.

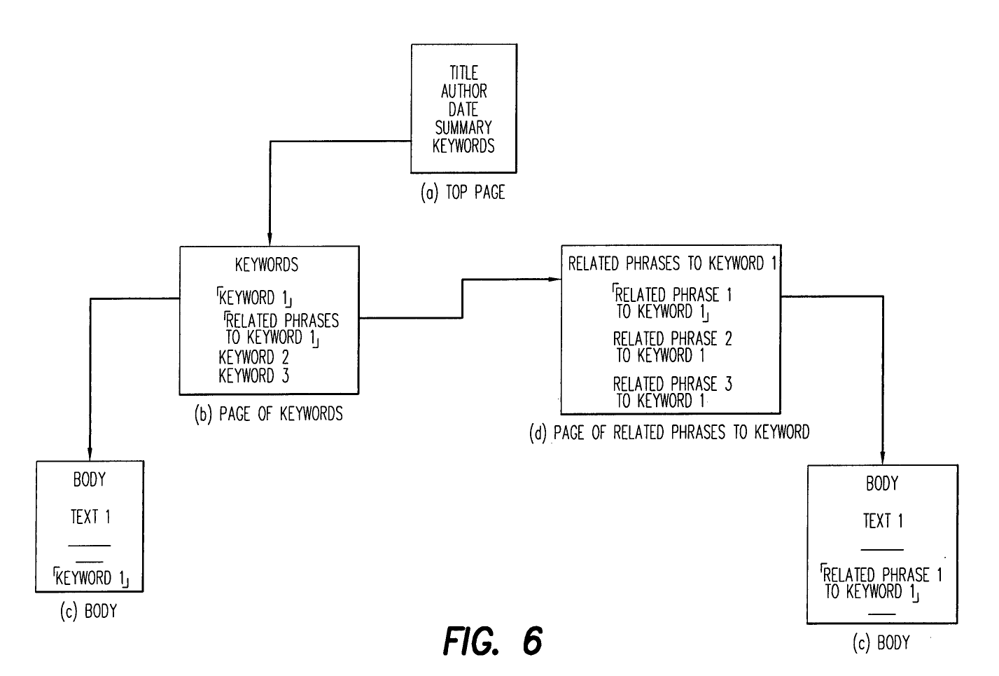

An example of the communications between a client or user and the contents transformation system 10 will now be explained with reference to FIG. 6. When the client device 20 displays a top page (a) and the client wants to know information about a “keyword” or a “key phrase relevant to a keyword”, he/she selects “keywords” to open a “keyword page” (b). An anchor to a page which contains the list of keywords and key phrases relevant to the respective keywords is indicated on the keyword page (b). When any of the keywords, for example, “keyword 1” is selected on the keyword page (b), the part of the “keyword 1” in the body of a document is displayed. In a case where a plurality of parts exist for the “keyword 1” within the identical document, these parts of the “keyword 1” are displayed in succession. Besides, when the client wants to know information about the “key phrase relevant to the keyword”, he/she designates, for example, a “key phrase relevant to the keyword 1” corresponding to the pertinent keyword (keyword 1) on the keyword page (b), thereby to open a “key phrase page” (d). Likewise, when the client selects a “key phrase 1 relevant to the keyword 1”, the part of the “key phrase 1 relevant to the keyword 1” in the body of the document is displayed. In a case where a plurality of parts exist for the “key phrase 1 relevant to the keyword 1” within the identical document, these parts of the “key phrase 1 relevant to the keyword 1” are displayed in succession.

In this manner, the client can readily grasp the whole document without going through all the document contents. Further, it is possible to cope with even the presence of such a limitation that the display screen of the client device 20 is small.

Accordingly, not only the display of Web contents on the display panel of a mobile device is facilitated, but also a more efficient access facility can be provided to the user of the mobile terminal device. It is also possible to realize a navigation mechanism which has hyperlinks permitting the client to readily judge whether or not the contents are necessary for him/her, without going through all the contents, and permitting the client to immediately move to a place that seems to be important within the contents. Further, it is possible to provide a facility which permits the client to browse information by the least access (communication) similarly to the above can be provided, not only for the contents composed of a single document, but also for the enormous contents composed of a plurality of documents.

Computer program codes for executing the operation of the present invention should desirably be created with an object-oriented programming language such as Java or C++. However, they can also be created with a conventional procedure-oriented programming language such as C, or a functional programming language.

In this embodiment, the contents transformation processing is implemented as a Java Servlet by using the Java programming language and is executed in the Web server 30. Alternatively, the processing can also be implemented as a common gateway interface (CGI) application or as logic contained in an active server page (ASP).

Besides, in this embodiment, all the program codes are executed on the Web server 30. It is also possible, however, to execute some of the program codes on the Web server 30 and the others on a Web proxy.

According to the present invention, not only the display of document contents on the display panel of a mobile terminal device is facilitated, but also more efficient access to the contents can be realized, owing to a dynamic contents transformation method in which new hyperlinks based on the key information of a document, such as keywords and key sentences, are generated with reference to the results of the semantic analysis of the document contents, and in which the document contents are appropriately divided on the basis of results obtained by semantically structuring the whole document, and terminal attributes indicating communication and display facilities incorporated in a terminal device making access.

Besides, information providing/browsing can be realized by the least access (communication) even for enormous Web contents, owing to a navigation mechanism which has hyperlinks permitting a client to readily judge whether or not the contents are necessary for him/her, from the summary, key elements, correlated keywords, etc. of at least one pertinent document and without going through all the contents, and permitting the client to immediately move to a place that seems important within the contents. These functions are very effective for access to the Web contents from, not only the mobile terminal device, but also a conventional desktop computer.

1. A method for transforming Web contents that contain one or more elements, in order to display the contents on a terminal device connected to a server computer with a communication network, comprising:
(a) the step of allowing said server computer to receive a request for access to said Web contents, from said terminal device;
(b) the step of retrieving semantic analysis results which concern the requested Web contents;
(c) the step of generating a transformation description object which associates at least one of the elements included in said Web contents with said semantic analysis results; and
(d) the step of transforming said at least one element so as to fit attributes of said terminal device, by using said transformation description object.

2. A method as defined in claim 1, wherein said step of retrieving said semantic analysis results which concern said Web contents includes the step of executing a semantic analysis for said Web contents.

3. A method as defined in claim 1, wherein said transformation description object is an extensible markup language (XML) document object.

4. A method as defined in claim 1, wherein said transformation description object contains either of link information for places where said at least one element associated appears within said Web contents, and link information for another of said elements as is relevant to the associated element.

5. A method as defined in claim 1, wherein said step of generating said transformation description object includes either of the step of dividing said at least one element into a plurality of elements, and the step of integrating the plurality of elements into at least one element.

6. A method as defined in claim 1, wherein said step of generating said transformation description object includes the step of generating at least one new relevant element by employing at least one of elements included in said Web contents and said semantic analysis results.

7. A method as defined in claim 1, wherein said step of transforming said at least one element includes the step of transforming said element so as to comply with a request made by a user of said terminal device.

8. An apparatus for transforming Web contents that contain one or more elements, in order to display the contents on a terminal device connected to a server computer with a communication network, comprising:
(a) means for allowing said server computer to receive a request for access to said Web contents, from said terminal device;
(b) means for retrieving semantic analysis results which concern the requested Web contents;
(c) means for generating a transformation description object which associates at least one of the elements included in said Web contents with said semantic analysis results; and
(d) means for transforming said at least one element so as to fit attributes of said terminal device, by using said transformation description object.
